(19) United States
(12) Patent Application Publication
(10) Pub. No.: US 2023/0307158 A1
(43) Pub. Date: Sep. 28, 2023

(54) SINTERED R-T-B BASED MAGNET

(71) Applicant: PROTERIAL, LTD., Tokyo (JP)

(72) Inventors: Daisuke FURUSAWA, Tokyo (JP); Futoshi KUNIYOSHI, Tokyo (JP)

(21) Appl. No.: 18/113,210

(22) Filed: Feb. 23, 2023

(30) Foreign Application Priority Data
Mar. 22, 2022 (JP) 2022-044855

(51) Int. Cl. H01F 1/055; C22C 38/00; C22C 38/10; C22C 38/16; C22C 38/14; C22C 38/06; C22C 33/04; B22F 9/02; B22F 9/04; B22F 1/10; B22F 3/16

(52) U.S. Cl. CPC H01F 1/0557; C22C 38/005; C22C 38/105; C22C 38/16; C22C 38/14; C22C 38/06; C22C 38/002; C22C 38/001; C22C 33/04; B22F 9/023; B22F 9/04; B22F 1/10; B22F 3/162; C22C 2202/02; B22F 2201/20; B22F 2009/044; B22F 2009/042; B22F 2304/10; B22F 2202/05; B22F 2301/35; B22F 2003/241

(57) ABSTRACT

A sintered R-T-B based magnet includes a main phase formed of an R₂T₁₄B compound and a grain boundary phase at grain boundaries of the main phase. The grain boundary phase contains an R-T-M compound (M is at least one selected from the group consisting of Ga, Cu, Zn, Al and Si) and an R-M compound. In any cross-section of the sintered R-T-B based magnet, a sum of an area ratio of the R-T-M compound and an area ratio of the R-M compound is not lower than 1.5% and not higher than 3.5%, the area ratio of the R-T-M compound is not lower than 0.4% and not higher than 2.5%, and the area ratio of the R-M compound is not lower than 0.4% and not higher than 2.5%.

### CROSS-REFERENCE TO RELATED APPLICATION

This application claims priority to Japanese Patent Application No. 2022-044855 filed on Mar. 22, 2022, the entire contents of which are hereby incorporated by reference.

### BACKGROUND

### 1. Technical Field

The present disclosure relates to a sintered R-T-B based magnet.

### 2. Description of the Related Art

Sintered R-T-B based magnets (where R is at least one of rare-earth elements; T is Fe, or Fe and Co; and B is boron) are known as permanent magnets with the highest performance. Therefore, the sintered R-T-B based magnets are used in various types of motors in the field of vehicles such as electric vehicles (EV, HV, PHV) and the like, in the field of renewable energy such as wind power generation and the like, in the field of consumer electronics, in the field of industrial equipment, and the like. The sintered R-T-B based magnets are indispensable to decrease the size and the weight of, to increase the efficiency of, and to realize energy savings for (to improve the energy efficiency of) these motors. The sintered R-T-B based magnets are also used in driving motors of electric vehicles. In the current state where vehicles using internal combustion engine are being replaced with electric vehicles, the sintered R-T-B based magnets contribute to decrease greenhouse gas such as carbon dioxide or the like (to decrease fuel gas and exhaust gas) and thus to prevent global warming. As can be seen, the sintered R-T-B based magnets significantly contribute to the realization of a clean energy society.

A sintered R-T-B based magnet includes a main phase which is mainly formed of an R₂T₁₄B compound and a grain boundary phase that is at the grain boundaries of the main phase. The R₂T₁₄B compound, which forms the main phase, is a ferromagnetic material having high saturation magnetization and an anisotropy field, and has a strong influence on the properties of the sintered R-T-B based magnet.

There exists a problem in that coercivity H_{cJ} (hereinafter, simply referred to as “H_{cJ}”) of sintered R-T-B based magnets decreases at high temperatures, thus causing an irreversible thermal demagnetization. For this reason, sintered R-T-B based magnets for use in motors for electric vehicles, in particular, are required to have high H_{cJ} even at high temperatures, i.e., to have higher H_{cJ} at room temperature.

### CITATION LIST

### Patent Literature

[Patent Document 1] International Publication No. 2013/008756

[Patent Document 2] International Publication No. 2018/143230

It is known that in the case where a light rare-earth element RL (mainly, Nd or Pr) in an R₂T₁₄B compound is replaced with a heavy rare-earth element RH (mainly, Tb or Dy), the H_{cJ} is improved. However, there is a problem that such a replacement, although improving the H_{cJ}, decreases the saturation magnetization of the R₂T₁₄B compound and therefore, decreases remanence Bᵣ (hereinafter, simply referred to as “Bᵣ”). Tb, particularly, is present in a very small quantity as resources and is produced in limited areas. For this and other reasons, Tb has problems of not being supplied stably and changing in costs. Therefore, it is demanded to provide high H_{cJ} while suppressing the decrease in the Bᵣ with Tb being used as little as possible (with Tb being used in a minimum possible amount).

International Publication No. 2013/008756 describes producing a sintered R-T-B based rare-earth magnet having high H_{cJ} with a suppressed content of Dy as follows. B is incorporated in a smaller amount than in a usual R-T-B based alloy, and at least one metal element M selected from Al, Ga and Cu is incorporated, to generate an R₂T₁₇ phase. The R₂T₁₇ phase is used as a raw material to generate a transition metal-rich phase (R₆T₁₃M). The above-mentioned sintered R-T-B based rare-earth magnet is provided with a sufficient volume fraction of the transition metal-rich phase (R₆T₁₃M).

International Publication No. 2018/143230 describes diffusing a heavy rare-earth element RH and light rare-earth elements RL and Ga from a surface of a sintered R-T-B based body into an interior thereof via grain boundaries. International Publication No. 2018/143230 also describes, as a preferred embodiment, that an R-T-Ga phase (corresponding to an R-T-M compound according to the present disclosure) is generated in a grain boundary phase of the sintered R-T-B based body to provide higher H_{cJ}.

### SUMMARY

It has been recently demanded to, particularly for the motors for electric vehicles and the like, provide higher Bᵣ and higher H_{cJ} with the amount of use of a heavy rare-earth element RH being decreased.

Various embodiments of the present disclosure provide a sintered R-T-B based magnet having high Bᵣ and high H_{cJ} with the amount of use of a heavy rare-earth element RH being decreased.

A sintered R-T-B based magnet according to the present disclosure includes, in a non-limiting illustrative embodiment, a main phase formed of an R₂T₁₄B compound (R is a rare-earth element and contains at least one selected from the group consisting of Nd, Pr and Ce; and T is Fe, or Fe and Co) compound; and a grain boundary phase at grain boundaries of the main phase. The grain boundary phase contains an R-T-M compound (M is at least one selected from the group consisting of Ga, Cu, Zn, Al and Si) and an R-M compound. Where R has a content (at %) represented as [R], T has a content (at o) represented as [T], and M has a content (at %) represented as [M], the contents of R, T and M in the R-T-M compound satisfy the relationships of 0.15≤[R]/([R]+[T]+[M])≤0.3, [T]/([R]+[T]+[M])≥0.6, and 0.015≤[M]/([R]+[T]+[M])≤0.1, and the contents of R and M in the R-M compound satisfy the relationships of 0.25≤[R]/([R]+[T]+[M])≤0.7 and 0.1<[M]/([R]+[T]+[M])≤0.3. In any cross-section of the sintered R-T-B based magnet, a sum of an area ratio of the R-T-M compound and an area ratio of the R-M compound is not lower than 1.5% and not higher than 3.5%, the area ratio of the R-T-M compound is not lower than 0.4% and not higher than 2.5%, and the area ratio of the R-M compound is not lower than 0.4% and not higher than 2.5%.

In an embodiment, the sintered R-T-B based magnet contains Ga and Cu, and a sum of a content of Ga and a content of Cu is not lower than 0.25 mass % and not higher than 2 mass %.

In an embodiment, the sintered R-T-B based magnet contains Ga and Cu, and a sum of a content of Ga and a content of Cu is not lower than 0.25 mass % and not higher than 0.65 mass %.

In an embodiment, R is contained in the sintered R-T-B based magnet at a content not lower than 28.5 mass % and not higher than 30.0 mass %.

In an embodiment, Tb is contained in the sintered R-T-B based magnet at a content not higher than 0.2 mass % (including 0 mass %), and Dy is contained in the sintered R-T-B based magnet at a content not higher than 0.4 mass % (including 0 mass %).

In an embodiment, the sintered R-T-B based magnet includes a portion in which at least one of a concentration of Nd and a concentration of Pr gradually decreases from a surface toward an interior thereof.

In an embodiment, the sintered R-T-B based magnet includes a portion in which a concentration of M gradually decreases from a surface toward an interior thereof.

In an embodiment, the sintered R-T-B based magnet includes a portion in which at least one of a concentration of Tb and a concentration of Dy gradually decreases from a surface toward an interior thereof.

Embodiments of the present disclosure provide a sintered R-T-B based magnet having high Bᵣ and high H_{cJ} with the amount of use of a heavy rare-earth element RH being decreased.

### BRIEF DESCRIPTION OF THE DRAWINGS

FIG. 1A is an enlarged schematic cross-sectional view of a part of a sintered R-T-B based magnet.

FIG. 1B is a further enlarged schematic cross-sectional view of the broken-lined rectangular region in FIG. 1A.

FIG. 2A is a perspective view schematically showing a sintered R-T-B based magnet 100 according to an embodiment of the present disclosure.

FIG. 2B is a graph showing an example of a portion, of the sintered R-T-B based magnet 100, in which at least one of a concentration of Nd and a concentration of Pr gradually decreases from a surface toward an interior thereof.

FIG. 3 is a flowchart showing example steps of a method for producing the sintered R-T-B based magnet according to an embodiment of the present disclosure.

### DETAILED DESCRIPTION

First, a fundamental structure of a sintered R-T-B based magnet according to the present disclosure will be described. The sintered R-T-B based magnet has a structure in which powder particles of a raw material alloy are bound together through sintering, and includes a main phase which is mainly formed of R₂T₁₄B compound grains and a grain boundary phase which is at the grain boundaries of the main phase.

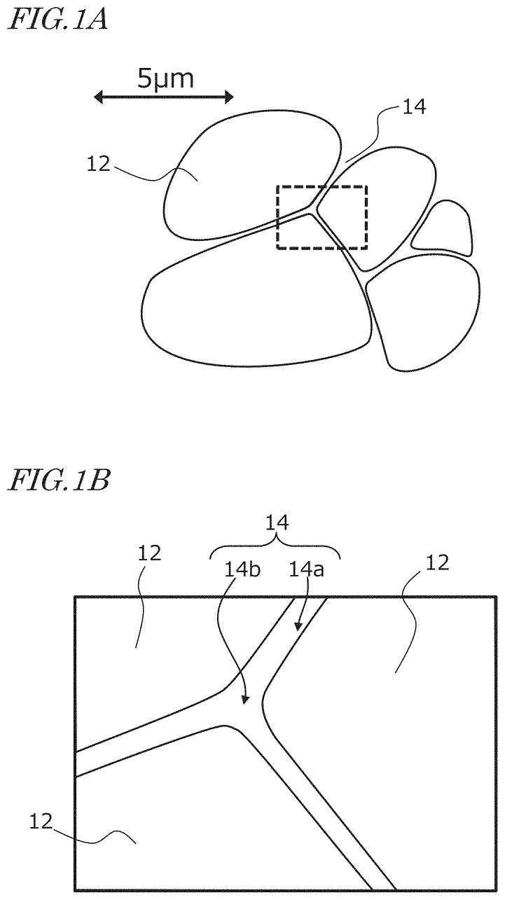

FIG. 1A is an enlarged schematic cross-sectional view of a part of a sintered R-T-B based magnet. FIG. 1B is a further enlarged schematic cross-sectional view of the broken-lined rectangular region in FIG. 1A. In FIG. 1A, a left-right arrow indicating a length of 5 μm is shown as an example of reference length to represent sizes. As shown in FIG. 1A and FIG. 1B, the sintered R-T-B based magnet includes a main phase 12 mainly formed of an R₂T₁₄B compound and a grain boundary phase 14 at the grain boundaries of the main phase 12. As shown in FIG. 1B, the grain boundary phase 14 includes an intergranular grain boundary phase 14a, along which two R₂T₁₄B compound grains adjoin each other, and a grain boundary triple junction 14b, at which three R₂T₁₄B compound grains adjoin one another. A typical crystal grain size of the main phase 12 is not shorter than 2 μm and not longer than 10 μm, this being an average value of the diameter of an approximating circle in a cross section of the magnet. The R₂T₁₄B compound, which forms the main phase 12, is a ferromagnetic material having high saturation magnetization and an anisotropy field. Therefore, in a sintered R-T-B based magnet, it is possible to improve the Bᵣ by increasing the abundance ratio of the R₂T₁₄B compound, which forms the main phase 12. In order to increase the abundance ratio of the R₂T₁₄B compound, an amount of R (R amount), an amount of T (T amount) and an amount of B (B amount) in the raw material alloy may be brought closer to the stoichiometric ratio of the R₂T₁₄B compound (i.e., the R amount: the T amount: the B amount=2:14:1).

However, because the sintered R-T-B based magnet also includes the grain boundary phase 14, R, T and B in the raw material alloy are consumed to form the grain boundary phase 14 as well as to form the main phase 12. The grain boundary phase 14 is partially melted during a sintering step and acts to physically bond the R₂T₁₄B compound grains, which form the main phase 12, to each other. Therefore, the grain boundary phase 14 is conventionally designed to have a rare-earth-rich (R-rich) composition having a relatively low melting point. Specifically, the R amount in the raw material alloy is conventionally set to be larger than the stoichiometric ratio thereof in the R₂T₁₄B compound, so that the resultant extra R is used to form the grain boundary phase. It is also known that the structure of the grain boundary phase 14, specifically, the types and the amounts of the substances contained in the grain boundary phase 14 influence the level of the H_{cJ}.

As described above, according to the method disclosed in International Publication No. 2013/008756 or International Publication No. 2018/143230, the transition metal-rich phase or the R-T-Ga phase is generated in the grain boundary phase of the sintered R-T-B based magnet to improve the H_{cJ}.

However, it has been found out as a result of the studies conducted by the present inventors that the generation of an R-T-M compound (corresponding to the transition metal-rich phase or the R-T-Ga phase mentioned above) improves the H_{cJ}, but this may undesirably result in the intergranular grain boundary phase becoming sufficiently thick to decrease the Bᵣ. It has also been found out by the studies conducted by the present inventors that an R-M compound, as well as the R-T-M compound, may be caused to exist to improve the H_{cJ} but this, similarly, may result in the intergranular grain boundary phase becoming sufficiently thick to decrease the Bᵣ. As can be seen, the R-T-M compound and the R-M compound need to be generated but the amounts thereof need to be minimized. As a result of conducting further studies based on such knowledge, the present inventors have found out that high Bᵣ and high H_{cJ} are both realized by controlling area ratios of the R-T-M compound and the R-M compound. Namely, the present disclosure relates to a finding that in the case where a sum of the area ratio of the R-T-M compound and the area ratio of the R-M compound is set to a specific range (not lower than 1.5% and not higher than 3.5%), the area ratio of the R-T-M compound is set to a specific range (not lower than 0.4% and not higher than 2.5%), and the area ratio of the R-M compound is set to a specific range (not lower than 0.4% and not higher than 2.5%), a sintered R-T-B based magnet with high Bᵣ and high H_{cJ} is produced with the amount of use of a heavy rare-earth element RH being decreased.

Hereinafter, a sintered R-T-B based magnet according to an embodiment of the present disclosure will be described in detail.

### <Sintered R-T-B Based Magnet>

The sintered R-T-B based magnet according to the present disclosure includes a main phase formed of an R₂T₁₄B compound and a grain boundary phase at the brain boundaries of the main phase. The grain boundary phase contains an R-T-M compound (M is at least one selected from the group consisting of Ga, Cu, Zn, Al and Si) and an R-M compound.

In the R-T-M compound and the R-M compound of the sintered R-T-B based magnet according to this embodiment, R is contained at content (at %) represented as [R], T is contained at a content (at %) represented as [T], and M is contained at a content (at %) represented as [M].

In the R-T-M compound according to the present disclosure, the contents of R, T and M satisfy the relationships of 0.15≤[R]/([R]+[T]+[M])≤0.3, [T]/([R]+[T]+[M])≥0.6, and 0.015≤[M]/([R]+[T]+[M])≤0.1. In the R-M compound, the contents of R and M satisfy the relationships of 0.25≤[R]/([R]+[T]+[M])≤0.7 and 0.1<[M]/([R]+[T]+[M])≤0.3. The contents of R, T and M in the R-T-M compound and the R-M compound may be measured by, for example, a point analysis performed by use of FE-SEM/WDXEDX (Field Emission Scanning Electron Microscope/Wavelength-Dispersive X-ray Spectroscopy-Energy-Dispersive X-ray Spectroscopy). Both of the R-T-M compound and the R-M compound, according to the present disclosure, having compositions in such ranges may be caused to exist in the grain boundary phase to provide high H_{cJ}. These compounds may be formed by, for example, adjusting the sintered R-T-B based magnet to have a composition described below or by diffusing an R-M alloy described below from a surface into an interior of the magnet.

According to the present disclosure, the R-T-M compound and the R-M compound are generated in amounts adjusted to specific ranges. Specifically, in any cross-section of the sintered R-T-B based magnet, the sum of the area ratio of the R-T-M compound and the area ratio of the R-M compound is not lower than 1.5% and not higher than 3.5%, the area ratio of the R-T-M compound is not lower than 0.4% and not higher than 2.5%, and the area ratio of the R-M compound is not lower than 0.4% and not higher than 2.5%. In the case where the sum of the area ratios of the R-T-M compound and the R-M compound, the area ratio of the R-T-M compound, and the area ratio of the R-M compound may all be adjusted to the ranges mentioned above, a sintered R-T-B based magnet having high Bᵣ and high H_{cJ} is provided. In the case where any one among the sum of the area ratios of the R-T-M compound and the R-M compound, the area ratio of the R-T-M compound, and the area ratio of the R-M compound is lower than the respective lower limit according to the present disclosure, the H_{cJ} may possibly be decreased. In the case where any one among the sum of the area ratios of the R-T-M compound and the R-M compound, the area ratio of the R-T-M compound, and the area ratio of the R-M compound is higher than the respective higher limit according to the present disclosure, the Bᵣ may possibly be decreased.

According to the present disclosure, the phrase “any cross-section” refers to a region having a size equal to, or larger than, 90 μm×90 μm of a cross-section of the sintered R-T-B based magnet obtained by the magnet being cut at any position. A plurality of BSE (backscattered electron) images of this region may be captured and analyzed by known image analysis software to find the area ratio of each of the R-T-M compound and the R-M compound and the sum of the area ratios.

Preferably, in any cross-section of the sintered R-T-B based magnet, the sum of the area ratio of the R-T-M compound and the area ratio of the R-M compound is not lower than 1.8% and not higher than 3.5%, the area ratio of the R-T-M compound is not lower than 0.4% and not higher than 2.0%, and the area ratio of the R-M compound is not lower than 0.4% and not higher than 1.5%. With such ranges, the sintered R-T-B based magnet may have higher Bᵣ and higher H_{cJ}.

The sintered R-T-B based magnet according to this embodiment may have, for example the composition containing:
R: not lower than 26.8 mass % and not higher than 33.0 mass % (containing at least one selected from the group consisting of Nd, Pr and Ce);
B: not lower than 0.85 mass % and not higher than 1.0 mass o;
Q1: not lower than 0.05 mass % and not higher than 2.0 mass % (Q1 is at least one selected from the group consisting of Ga, Cu, Zn, Al and Si);
Q2: not lower than 0 mass % and not higher than 2.0 mass % (Q2 is at least one selected from the group consisting of Ti, V, Cr, Mn, Ni, Zr, Nb, Mo, Ag, In, Sn, Hf, Ta, W, Pb and Bi); and
the remaining part T (T is Fe, or Fe and Co) and unavoidable impurities.

In the sintered R-T-B based magnet according to this embodiment, B has an atomic ratio with respect to T that is lower than the atomic ratio of B with respect to T in the stoichiometric composition of the R₂T₁₄B compound. This is represented by expression (1) below by use of the mass ratio (mass %), instead of the atomic ratio (T is based on Fe, and therefore, the atomic weight of Fe is used). T is contained at a mass ratio (mass %) represented as [[T]], and B is contained at a mass ratio (mass %) represented as [[B]].

[[T]]/55.85>14×[[B]]/10.8 (1)

Expression (1) is satisfied and Q1 is incorporated, and as a result, the R-T-M compound and the R-M compound are generated in the grain boundary phase. Therefore, the relationship between expression (1) and the Q1 (the contents of T, B and Q1) may be adjusted and production conditions including heat treatment conditions and the like may be adjusted to adjust the amounts of generation of the R-T-M compound and the R-M compound. Alternatively, the amounts of generation of the R-T-M compound and the R-M compound may be adjusted by a method of diffusing the R-M alloy from the surface into the interior of the magnet described below.

R may contain, for example, Dy, Tb, Ho, La, Ce, Pr, Gd, Y, Sm, Eu or the like. Preferably, R is contained at a content not lower than 28.5 mass % and not higher than 30.0 mass %. With such a range, higher Bᵣ and higher H_{cJ} are provided. The sintered R-T-B based magnet according to the present disclosure provides high Bᵣ and high H_{cJ} while the amount of use of the heavy rare-earth element RH is decreased. Therefore, preferably, Tb is contained at a content not higher than 0.2 mass % (including 0 mass %), and Dy is contained at a content not higher than 0.4 mass (including 0 mass %). More preferably, the sintered R-T-B based magnet does not contain Tb (except for as unavoidable impurities); still more preferably, the sintered R-T-B based magnet does not contain Dy (except for as unavoidable impurities); and yet more preferably, the sintered R-T-B based magnet contains neither Tb nor Dy (except for as unavoidable impurities). The sintered R-T-B based magnet contains O (oxygen), N (nitrogen), C (carbon) and the like as unavoidable impurities.

Preferably, the sintered R-T-B based magnet contains Ga and Cu, and a sum of a content of Ga and a content of Cu is not lower than 0.25 mass % and not higher than 2 mass %. Ga and Cu thus contained allows the R-T-M compound and the R-M compound to be generated with more certainty. More preferably, the sum of the content of Ga and the content of Cu is not lower than 0.25 mass % and not higher than 0.65 mass %. With such a range, higher Bᵣ and higher H_{cJ} are provided.

The sintered R-T-B based magnet according to this embodiment preferably includes a portion in which at least one of a concentration of Nd and a concentration of Pr gradually decreases from the surface toward the interior of the magnet. At least one of Nd and Pr is diffused from the surface into the interior of the magnet. As a result, the sintered R-T-B based magnet includes a portion in which at least one of the Nd concentration and the Pr concentration gradually decreases from the surface toward the interior of the magnet. At least one of Nd and Pr may be diffused from the surface into the interior of the magnet to improve the H_{cJ}.

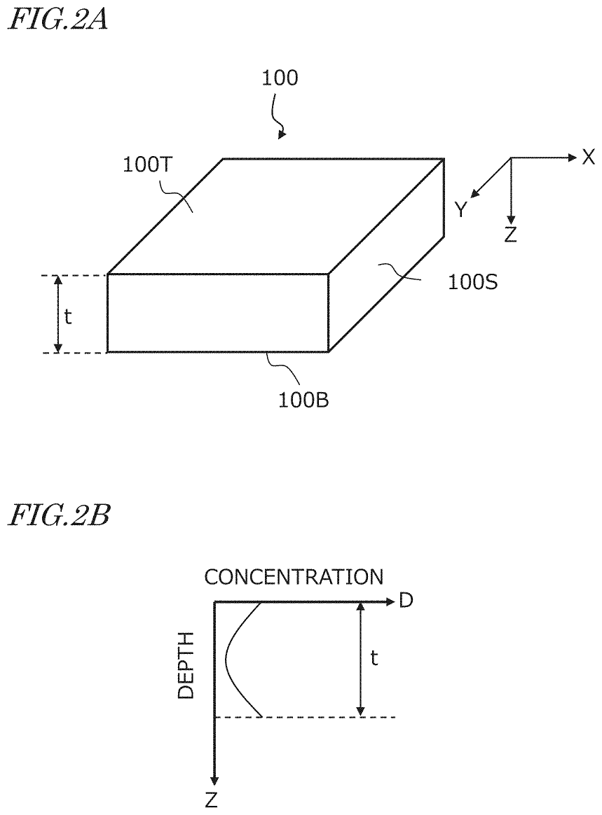

FIG. 2A is a perspective view schematically showing a sintered R-T-B based magnet 100 according to this embodiment. FIG. 2B is a graph showing an example of a portion of the sintered R-T-B based magnet 100 in which at least one of the Nd concentration and the Pr concentration gradually decreases from the surface toward the interior thereof. FIG. 2A shows an X axis, a Y axis and a Z axis perpendicular to each other for reference.

In the example shown in FIG. 2A, the sintered R-T-B based magnet 100 has a top surface 100T, a bottom surface 100B and side surfaces 100S, which each correspond to a part of the surface of the magnet. The size in a Z-axis direction of the sintered R-T-B based magnet 100 is thickness t. In the graph shown in FIG. 2B, the vertical axis represents the depth (Z) from the top surface 100T of the sintered R-T-B based magnet 100, and the horizontal axis represents the concentration (D) of at least one of Nd and Pt. In this embodiment, Pr is diffused from each of the top surface 100T and the bottom surface 100B into the interior of the sintered R-T-B based magnet 100. As a result, as shown in FIG. 2B, a portion in which the Pr concentration gradually decreases from the surface toward the interior of the magnet is present on both of the top surface 100T side and the bottom surface 100B side as seen from the center of the magnet.

The significance of the sintered R-T-B based magnet 100 including a portion in which at least one of the Nd concentration and the Pr concentration gradually decreases from the surface toward the interior thereof will be described. As described above, the state where the sintered R-T-B based magnet 100 includes a portion in which at least one of the Nd concentration and the Pr concentration gradually decreases from the surface toward the interior thereof indicates a state where at least one of Nd and Pr is diffused from the surface into the interior of the magnet. This state may be confirmed by, for example, a line analysis performed by use of WDX or EDX on a region, of any cross-section of the sintered R-T-B based magnet 100, from the surface to the vicinity of the center thereof.

The Nd and Pr concentrations may vary in accordance with whether the site of measurement is in the main phase crystal grains (R₂T₁₄B compound grains) or at the grain boundaries, in the case where the site of measurement has a size of, for example, submicron order. In the case where the site of measurement is at the grain boundaries, the Nd or Pr concentration may vary locally or microscopically in accordance with the type or the manner of distribution of an Nd or Pr-containing compound that may be formed at the grain boundaries. However, in the case where Nd or Pr is diffused from the surface into the interior of the magnet, it is unequivocal that an average value of the concentrations of such an element at positions at an equal depth from the surface of the magnet gradually decreases from the surface toward the interior of the magnet. According to the present disclosure, in the case where at least one of the average concentration values of Nd and Pr, each measured with the depth being the function, decreases along with an increase in the depth in at least a region from the surface to a depth of 200 μm of the sintered R-T-B based magnet, it is defined that the sintered R-T-B based magnet includes a portion in which at least one of the Nd concentration and the Pr concentration gradually decreases.

During the production of the sintered R-T-B based magnet according to this embodiment, preferably, a metal element M (M is at least one selected from the group consisting of Ga, Cu, Zn, Al and Si), in addition to at least one of Nd and Pr, may be diffused from the surface into the interior of the magnet. Therefore, in a more preferred embodiment, the sintered R-T-B based magnet includes a portion in which a concentration of M (M is at least one selected from the group consisting of Ga, Cu, Zn, Al and Si) gradually decreases from the surface toward the interior thereof. The R-T-M compound and the R-M compound may be generated by a method of diffusing R and M (e.g., an R-M alloy) from the surface into the interior of the magnet. The amount of generation of M may be adjusted by adjusting conditions of diffusion (conditions such as the amounts of introduction of R and M, the temperature of diffusion, and the like). Similarly, preferably, the sintered R-T-B based magnet includes a portion in which at least one of a concentration of Tb and a concentration of Dy gradually decreases from the surface toward the interior thereof. This also indicates that Tb or Dy, for example, is diffused from the surface into the interior of the magnet, like in the case of Nd and Pr. Tb or Dy, for example, may be diffused from the surface into the interior of the magnet to provide higher H_{cJ}.

The state where the sintered R-T-B based magnet includes a portion in which the concentration of at least one of Nd and Pr, the concentration of M, and the concentration of at least one of Tb and Dy gradually decrease from the surface toward the interior thereof indicates a state where these elements are diffused from the surface into the interior of the magnet. Whether or not the sintered R-T-B based magnet “includes a portion in which the concentration of a predetermined element gradually decreases from the surface toward the interior thereof” may be confirmed by, for example, a line analysis performed by use of WDX or EDX on a region, of any cross-section of the sintered R-T-B based magnet, from the surface to the vicinity of the center thereof. There may be a case where the concentration of such a predetermined element is increased or decreased locally in accordance with whether the site of measurement is in the main phase crystal grains (R₂T₁₄B compound grains) or at the grain boundaries, or in accordance with the type or the presence/absence of a compound, containing R and the metal element M, that is generated in the pre-diffusion sintered R-T-B based body or at the time of diffusion. However, the overall concentration gradually decreases toward the interior of the magnet. Therefore, even if the concentration of a predetermined element is increased or decreased locally, the sintered R-T-B based magnet is deemed to be in the state of “including a portion in which the concentration of a predetermined element gradually decreases from the surface toward the interior thereof” as defined by the present disclosure.

### <Method for Producing the Sintered R-T-B Based Magnet>

Hereinafter, a method for producing the sintered R-T-B based magnet according to an embodiment of the present disclosure will be described.

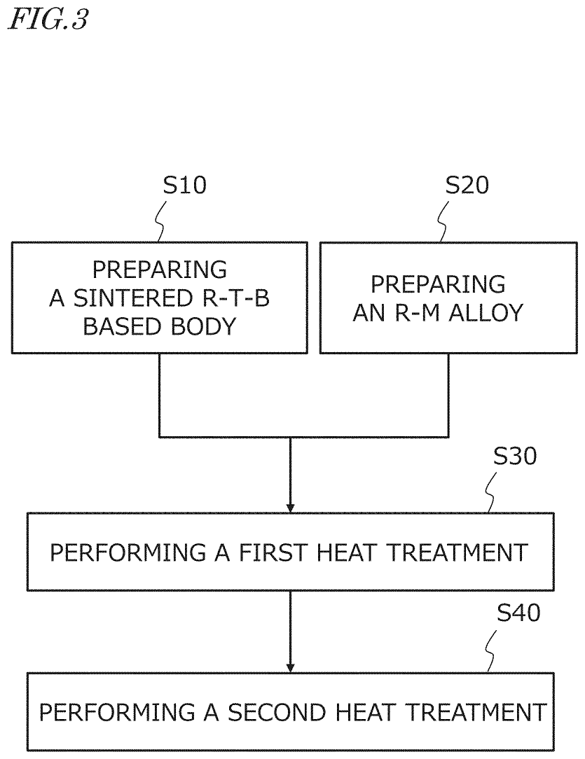

As shown in FIG. 3, the production method according to this embodiment may include, for example, step S10 of preparing a sintered R-T-B based body, step S20 of preparing an R-M alloy, step S30 of performing a first heat treatment, and step S40 of performing a second heat treatment. In step S30, the sintered R-T-B based body and the R-M alloy are subjected to a first heat treatment at a temperature not lower than 700° C. and not higher than 950° C. in a vacuum or an inert gas atmosphere, while at least a portion of the R-M alloy is kept in contact with at least a portion of the surface of the sintered R-T-B based body. As a result, R and M are diffused into the interior of the magnet. In step S40, the sintered R-T-B based magnet produced as a result of the first heat treatment is subjected to a second heat treatment at a temperature that is not lower than 400° C. and not higher than 750° C. but is lower than the temperature of the first heat treatment, in a vacuum or an inert gas atmosphere. The R-M alloy is diffused from the surface into the interior of the magnet, and as a result, higher Bᵣ and higher H_{cJ} are provided.

The production method according to this embodiment does not need to include the step of diffusion. As described above, the composition of the sintered R-T-B based magnet (the contents of T, B and Q1) may be adjusted and the production conditions including the heat treatment conditions and the like may be adjusted to adjust the amounts of generation of the R-T-M compound and the R-M compound. In this case also, the sintered R-T-B based magnet according to the present disclosure is provided.

Hereinafter, these steps will be described in more detail.

### (Step of Preparing the Sintered R-T-B Based Body)

First, a composition of the sintered R-T-B based body will be described.

The sintered R-T-B based body prepared in this step has, for example, the composition containing:
R: not lower than 26.6 mass % and not higher than 32.8 mass % (R is at least one of rare-earth elements, and contains Nd);
B: not lower than 0.85 mass % and not higher than 1.0 mass o;
Q1: not lower than 0 mass % and not higher than 1.5 mass % (Q1 is at least one selected from the group consisting of Ga, Cu, Zn, Al and Si);
Q2: not lower than 0 mass % and not higher than 2.0 mass % (Q2 is at least one selected from the group consisting of Ti, V, Cr, Mn, Ni, Zr, Nb, Mo, Ag, In, Sn, Hf, Ta, W, Pb and Bi); and
the remaining part T (T is Fe, or Fe and Co) and unavoidable impurities.

The sintered R-T-B based body also satisfies expression (1) above.

Now, a method for preparing the sintered R-T-B based body will be described.

A metal material or an alloy adjusted in advance to have the above-described composition is melted, and the melted metal material or alloy is treated with an ingot casting method; specifically, put into a casting mold and solidified. As a result, an alloy ingot is produced. Alternatively, a strip casting method may be used, by which a metal material or an alloy adjusted in advance to have the above-described composition is melted, and the melted metal material or alloy is quenched by being in contact with a single roll, a twin roll, a rotary disc, a rotary cylindrical casting mold or the like to produce a quenched solidified alloy. Another quenching method such as a centrifugal casting method or the like may be used to produce a flake-like alloy.

According to an embodiment of the present disclosure, an alloy produced by either the ingot method or the quenching method is usable. It is preferred to use an alloy produced by the quenching method such as the strip casting method or the like. The alloy produced by the quenching method usually has a thickness in the range of 0.03 mm to 1 mm, and is flake-like. The melted alloy starts solidifying from a surface thereof that is in contact with a cooling roll (roll contact surface), and a crystal grows like a column in a thickness direction from the roll contact surface. The quenched alloy has been cooled in a shorter time period than an alloy (alloy ingot) produced by the conventional ingot casting method (mold casting method), and therefore, has a finer tissue, a shorter crystal grain size, and a larger area of grain boundaries. The R-rich phase largely expands in the grain boundaries, and the quenching method is highly effective in dispersing the R-rich phase. For this reason, the R-rich phase is easily broken at the grain boundaries by a hydrogen pulverizing method. The quenched alloy may be hydrogen-pulverized, so that the hydrogen-pulverized powder (coarse-pulverized powder) has a size that is, for example, not longer than 1.0 mm. The coarse-pulverized powder formed in this manner is pulverized by a jet mill.

The jet mill pulverization is performed in an atmosphere of inert gas such as nitrogen. The pulverization may be performed by, for example, a jet mill in a humid atmosphere. Preferably, the powder particles are decreased in the particle size (the average particle size is not shorter than 2.0 μm and not longer than 10.0 μm; more preferably, is not shorter than 2.0 μm and not longer than 8.0 μm; still more preferably, is not shorter than 2.0 μm and not longer than 4.5 μm; and yet more preferably, is not shorter than 2.0 μm and not longer than 3.5 μm). The powder particles may be made small to provide high H_{cJ}.

Fine-pulverized powder to be used to produce the sintered R-T-B based body may be formed of one type of raw material alloy (single raw-material alloy) or formed by a method of mixing two or more types of raw material alloys (by a blend method) as long as the above-described conditions are satisfied.

According to a preferred embodiment, a powder compact is formed of the above-mentioned fine-pulverized powder by a magnetic field press, and then is sintered. Preferably, the magnetic field press is performed in an inert gas atmosphere or by a wet press from the point of view of suppressing oxygen. In the case where, in particular, the wet press is used, surfaces of particles that form the powder compact are covered with a dispersant such as oil or the like and thus is suppressed from being in contact with oxygen or water vapor in the air. Therefore, the particles are prevented or suppressed from being oxidized by the air before, during, or after the pressing step. This makes it easy to control the content of oxygen to be within a predetermined range. In the case where the magnetic field wet press is performed, a slurry of the fine-pulverized powder mixed with a dispersion medium is prepared, and is supplied to a cavity of a mold of a wet press device to be pressed in a magnetic field. Alternatively, the sintered R-T-B based body may be prepared by a known method such as the PLP (Press-Less Process) described in, for example, Japanese Laid-Open Patent Publication No. 2006-19521, instead of such a press method being used.

Next, the compact is sintered to produce the sintered R-T-B based body. The compact is sintered at a pressure that is preferably not higher than 1300 Pa (10 Torr), and more preferably not higher than 700 pa (5 Torr), and at a temperature in the range of 950° C. to 1150° C. In order to prevent the compact from being oxidized by sintering, the remaining gas in the atmosphere may be replaced with inert gas such as helium, argon or the like. The obtained sintered body may be heat-treated. The conditions of heat treatment such as the heat treatment temperature, the heat treatment time and the like may be known conditions.

### (Step of Preparing the R-M Alloy)

An alloy containing R, or R and M, is diffused from the surface into the interior of the sintered R-T-B based body. For performing this, an R-M alloy containing the element(s) to be diffused is prepared.

First, a composition of the R-M alloy will be described. In the R-M alloy, R is a rare-earth element, and contains at least one selected from the group consisting of Nd, Pr and Ce. Preferably, with respect to the entirety of the R-M alloy, R is contained at a content that is not lower than 65 mass % and not higher than 100 mass %, and M is contained at a content that is not lower than 0 mass % and not higher than 35 mass %. R preferably contains Pr, and the content of Pr in R is preferably not lower than 65 mass % and not higher than 86 mass % with respect to the entirety of the R-M alloy. The content of Pr in the R-M alloy is preferably not lower than 50 mass %, and more preferably not lower than 65 mass % with respect to the entirety of R. In the case where R contains Pr, the diffusion in the grain boundary phase progresses easily, which allows the diffusion in the grain boundaries to be promoted. As a result, higher H_{cJ} is provided.

The R-M alloy may have any shape or size with no specific limitation. The R-M alloy may be in the form of film, foil, powder, blocks, particles or the like.

Now, a method for preparing the R-M alloy will be described.

The R-M alloy may be prepared by a method for producing a raw material alloy that is adopted in generic methods for producing a sintered R-T-B based magnet, e.g., a mold casting method, a strip casting method, a single roll rapid quenching method (melt spinning method), an atomization method, or the like. Alternatively, the R-M alloy may be prepared by pulverizing an alloy obtained as above with a known pulverization device such as a pin mill or the like.

### (Step of Performing the First Heat Treatment)

A diffusion step is performed, by which the sintered R-T-B based body and the R-M alloy prepared by the above-described methods are subjected to the first heat treatment at a temperature not lower than 700° C. and not higher than 950° C. in a vacuum or an inert gas atmosphere, while at least a portion of the R-M alloy is kept in contact with at least a portion of the surface of the sintered R-T-B based body, to diffuse R and M into the interior of the magnet. As a result, a liquid phase containing R and M is generated from the R-M alloy, and the liquid phase is introduced from the surface into the interior of the sintered body through diffusion, via the grain boundaries in the sintered R-T-B based body.

In the case where the temperature of the first heat treatment is lower than 700° C., the amount of the liquid phase containing, for example, R and M is too small to provide high H_{cJ}. By contrast, in the case where the temperature of the first heat treatment is higher than 950° C., the H_{cJ} may possibly be decreased. Preferably, the temperature of the first heat treatment is not lower than 850° C. and not higher than 950° C. With such a temperature range, higher H_{cJ} is provided. It is preferred that the sintered R-T-B based magnet produced as a result of the first heat treatment (not lower than 700° C. and not higher than 950° C.) is cooled down to 300° C. at a cooling rate of at least 5° C./minute from the temperature of the first heat treatment. With such cooling, higher H_{cJ} is provided. More preferably, the cooling rate down to 300° C. is at least 15° C./minute.

The first heat treatment may be performed by use of a known heat treatment apparatus on the R-M alloy of any shape located on the surface of the sintered R-T-B based body. For example, the first heat treatment may be performed while the surface of the sintered R-T-B based body is covered with a powder layer of the R-M alloy. For example, a slurry having the R-M alloy dispersed in a dispersion medium may be applied onto the surface of the sintered R-T-B based body, and then the dispersion medium may be evaporated to allow the R-M alloy to come into contact with the sintered R-T-B based body. Examples of the dispersion medium include alcohols (ethanol, etc.), aldehydes, and ketones. The heavy rare-earth element RH is not limited to being introduced from the R-M alloy, but may also be introduced from a fluoride, an oxide, an oxyfluoride or the like of the heavy rare-earth element RH located, together with the R-M alloy, on the surface of the sintered R-T-B based magnet. Examples of the fluoride, oxide, and oxyfluoride of the heavy rare-earth element RH include TbF₃, DyF₃, Tb₂O₃, Dy₂O₃, TbOF, and DyOF.

The R-M alloy may be located at any position as long as at least a portion thereof is in contact with at least a portion of the sintered R-T-B based body.

### (Step of Performing the Second Heat Treatment)

The sintered R-T-B based body produced as a result of the first heat treatment is subjected to a heat treatment at a temperature that is not lower than 400° C. and not higher than 750° C. but is lower than the temperature used in the step of performing the first heat treatment, in a vacuum or an inert gas atmosphere. In the present disclosure, this heat treatment is referred to as the “second heat treatment”. The second heat treatment allows high H_{cJ} to be provided. In the case where the second heat treatment is performed at a temperature higher than that of the first heat treatment, or in the case where the temperature of the second heat treatment is lower than 400° C. or higher than 750° C., high H_{cJ} may not possibly be provided.

### EXAMPLES

An embodiment according to the present disclosure will be described in more detail by way of examples. The embodiment according to the present disclosure is not limited to any of the examples.

Electrolytic iron, Nd metal, Pr metal, Dy metal, ferroboron alloy, electrolytic Co, Al metal, Cu metal, Ga metal and Zr metal were combined so as to have an intended composition, and these raw materials were melted and cast by a strip casting method. As a result, a flake-like raw material alloy was obtained. The obtained flake-like raw material alloy was hydrogen-embrittled in a high pressure hydrogen atmosphere. Then, the resultant substance was subjected to dehydrogenation; specifically, was heated to 550° C. in a vacuum and then cooled to obtain coarse-pulverized powder. Next, phosphite ester as a lubricant was incorporated into, and mixed with, the obtained coarse-pulverized powder, and then the resultant substance was dry-milled in a nitrogen jet by an airflow crusher (jet mill machine) to obtain fine-pulverized powder (alloy powder) having a particle size D₅₀ of about 3 μm. In this experiment example, the amount of moisture in the nitrogen gas at the time of milling was adjusted such that the sintered magnet obtained as a final product would contain oxygen in an amount of 0.1 to 0.2 mass %. The particle size D₅₀ is a value obtained by an airflow-dispersion laser diffraction method (volume-based median size). After a lubricant was incorporated into the fine-pulverized powder, the resultant substance was immersed in mineral oil to prepare a slurry. The obtained slurry was pressed in a magnetic field (wet press) to obtain a compact. As a pressing apparatus, a so-called orthogonal magnetic field pressing apparatus (transverse magnetic field pressing apparatus) was used, in which the direction of magnetic field application was orthogonal to the pressurizing direction. The obtained compact was kept at a temperature of 1020° C. to 1050° C. (a temperature at which a sufficiently dense texture would result through sintering was selected) for about 5 hours in a vacuum to be sintered, and as a result, sintered works were obtained. The sintered works all had a density not lower than 7.5 Mg/m³. The obtained sintered works were subjected to mechanical processing to produce cuboid samples having a length of 7.5 mm, a width of 7.5 mm and a height of 7.2 mm. The height direction is the direction of magnetic field application.

Pr metal, Tb metal, Cu metal and Ga metal were combined so as to have an intended composition, and these raw materials were melted to obtain alloy powder (diffusion source) by a disc atomization method. The composition of the powder was analyzed by ICP (Inductively Coupled Plasma) optical emission spectroscopy. The results were 0.5 Nd-76.5 Pr-13.4 Tb-4.6 Cu-5.1 Ga (mass %).

Regarding the cuboid sintered work, a 5% solution of poly(vinyl alcohol) was applied onto two surfaces defined by the length direction and the width direction, and the diffusion source powder was applied thereon. The diffusion source powder was applied at 1.5% (weight ratio with respect to the sintered work) for each surface, namely, at 3% for the two surfaces. The post-application sample was kept at 900° C. for 10 hours in a vacuum, and then was cooled down to room temperature. Then, the sample was kept at 500° C. for 1 hour in a vacuum, and then was cooled down to room temperature. Such a post-heat treatment sample was subjected to mechanical processing to obtain a cuboid having a length of 4.0 mm, a width of 4.0 mm and a height of 7.0 mm. The Bᵣ of the cuboid was measured by a B-H tracer, and the H_{cJ} of the cuboid was measured by a pulse B-H tracer. After being subjected to magnetization measurement, the sample was thermally demagnetized at 350° C. Then, the contents of Nd, Pr, Dy, Tb, B, Co, Al, Cu, Ga and Zr in the magnet were measured by ICP optical emission spectroscopy, with the entire amount thereof being dissolved. A scrap piece of the sintered work obtained after the diffusion source was removed was pulverized in a mortar. The amounts of O (oxygen), N (nitrogen) and C (carbon) were measured by gas analysis, respectively by use of a gas fusion infrared absorption method, a gas fusion heat transfer method, and a combustion infrared absorption method. The results are shown in Table 1. In comparative example 1, the Bᵣ was relatively high, but the H_{cJ} was lower than 2000 kA/m. In example 2 and example 3, the Bᵣ exhibited a high level of at least 1.4 T, and the H_{cJ} also exhibited a high level of at least 2000 kA/m.

TABLE 1

| SAMPLE | OVERALL COMPOSITION AFTER DIFFUSION (mass %) | | | | | | | | | | | | | | | Br | HcJ |
|---|---|---|---|---|---|---|---|---|---|---|---|---|---|---|---|---|---|
| No. | Fe | Nd | Pr | Dy | Tb | Co | Cu | Ga | Al | Ni | Zr | B | O | N | C | (T) | (kA/m) |
| COMPAR- | 68.2 | 22.2 | 6.89 | 0.29 | 0.20 | 0.10 | 0.14 | 0.23 | 0.06 | 0.01 | 0.11 | 0.910 | 0.10 | 0.05 | 0.12 | 1.446 | 1900 |
| ATIVE EX. 1 | | | | | | | | | | | | | | | | | |
| EXAM- | 68.0 | 22.2 | 7.07 | 0.29 | 0.18 | 0.10 | 0.15 | 0.24 | 0.05 | 0.01 | 0.11 | 0.886 | 0.13 | 0.04 | 0.12 | 1.420 | 2053 |
| PLE 2 | | | | | | | | | | | | | | | | | |
| EXAM- | 68.2 | 22.2 | 6.99 | 0.29 | 0.18 | 0.10 | 0.14 | 0.23 | 0.06 | 0.01 | 0.11 | 0.904 | 0.15 | 0.03 | 0.12 | 1.433 | 2017 |
| PLE 3 | | | | | | | | | | | | | | | | | |

A scrap piece of the sintered work still having the diffusion source remaining thereon was used to analyze the surface by FE-SEM/WDXEDX (Field Emission Scanning Electron Microscope/Wavelength-Dispersive X-ray Spectroscopy-Energy-Dispersive X-ray Spectroscopy) performed on a cross-section (a cross-section defined by the length direction and the width direction). The analysis was performed on a region of 500 μm from the interface between the diffusion source and the sintered work. WDX was used to analyze Al, Ni, Zr, B, O, N and C, and EDX was used to analyze Fe and Nd. Table 2 shows the results of the point analysis performed on the R-T-M compound, and Table 3 shows the results of the point analysis performed on the R-M compound. In the tables, R represents Nd+Pr+Dy+Tb, T represents Fe+Co, and M represents Cu+Ga+Al . In comparative example 1, the R-T-M compound was not observed at any site. A region, of any cross-section of the sintered R-T-B based magnet, from the surface to the vicinity of the center thereof was subjected to a line analysis performed by use of WDX. As a result, the sintered R-T-B based magnet was confirmed to include a portion in which the Pr concentration, the M concentration (Ga and Cu) and the Tb concentration gradually decreased from the surface toward the interior thereof.

TABLE 2

| SAMPLE | R-T-M COMPOUND - POINT ANALYSIS RESULTS (at. %) | | | | | | | | | | | | | | | | | | R/(R + | T/(R + | M/(R + |
|---|---|---|---|---|---|---|---|---|---|---|---|---|---|---|---|---|---|---|---|---|---|
| No. | Fe | Nd | Pr | Dy | Tb | Co | Cu | Ga | Al | Ni | Zr | B | C | N | O | R | T | M | T + M) | T + M) | T + M) |
| COMPARA- | — | — | — | — | — | — | — | — | — | — | — | — | — | — | — | — | — | — | — | — | — |
| TIVE EX. 1 | | | | | | | | | | | | | | | | | | | | | |
| EXAM- | 72.4 | 10.1 | 5.9 | 0.0 | 0.2 | 0.0 | 0.2 | 1.4 | 0.0 | 0.0 | 0.0 | 0.0 | 7.1 | 1.4 | 1.2 | 16.2 | 72.4 | 1.6 | 0.180 | 0.802 | 0.018 |
| PLE 2 | | | | | | | | | | | | | | | | | | | | | |
| EXAM- | 74.4 | 10.7 | 5.4 | 0.0 | 0.0 | 0.0 | 0.0 | 2.1 | 0.0 | 0.0 | 0.0 | 0.0 | 5.6 | 0.5 | 1.3 | 16.1 | 74.4 | 2.1 | 0.174 | 0.803 | 0.023 |
| PLE 3 | | | | | | | | | | | | | | | | | | | | | |

TABLE 3

| SAMPLE | R-M COMPOUND - POINT ANALYSIS RESULTS (at. %) | | | | | | | | | | | | | | | | | | R/(R + | T/(R + | M/(R + |
|---|---|---|---|---|---|---|---|---|---|---|---|---|---|---|---|---|---|---|---|---|---|
| No. | Fe | Nd | Pr | Dy | Tb | Co | Cu | Ga | Al | Ni | Zr | B | C | N | O | R | T | M | T + M) | T + M) | T + M) |
| COMPARA- | 46.7 | 15.1 | 14.1 | 0.0 | 0.1 | 0.5 | 4.5 | 7.6 | 0.0 | 0.1 | 0.0 | 0.0 | 8.4 | 1.7 | 1.0 | 29.4 | 47.2 | 12.2 | 0.331 | 0.532 | 0.137 |
| TIVE EX. 1 | | | | | | | | | | | | | | | | | | | | | |
| EXAM- | 38.3 | 17.9 | 19.0 | 0.0 | 0.3 | 1.0 | 5.6 | 6.2 | 0.0 | 0.3 | 0.0 | 0.0 | 5.6 | 3.6 | 2.1 | 37.2 | 39.3 | 11.8 | 0.421 | 0.445 | 0.133 |
| PLE 2 | | | | | | | | | | | | | | | | | | | | | |
| EXAM- | 41.5 | 15.6 | 16.6 | 0.0 | 0.2 | 0.8 | 6.4 | 7.5 | 0.6 | 0.0 | 0.0 | 0.0 | 5. 4 | 3.5 | 2.0 | 32.3 | 42.3 | 14.5 | 0.363 | 0.475 | 0.162 |
| PLE 3 | | | | | | | | | | | | | | | | | | | | | |

Four BSE (backscattered electron) images of a region of 120 μm×90 μm were captured at each of depths. The captured BSE images were analyzed to calculate the area ratios of the phases. For the image analysis, Scandium (produced by SEIKA Digital Image Corporation) was used. 256 stages of brightness were allocated to each phase, the numbers of pixels were counted, and the numbers of pixels of four fields of view were averaged. Thus, the area ratio of each of the phases was calculated. The results of the calculation are shown in Table 4. As described above, in comparative example 1, the R-T-M compound was not observed, and the sum of the area ratios of the R-T-M compound and the R-M compound exhibited a low level of lower than 1.5%. By contrast, in example 2 and example 3, the area ratio of the R-T-M compound was not lower than 0.4% and not higher than 2.5%, and the sum of the area ratios of the R-T-M compound and the R-M compound was not lower than 1.5% and not higher than 3.5%. There values are not too high or not too low. It is considered that such an appropriate ratio between the phases realizes both of high Bᵣ and high H_{cJ}.

TABLE 4

| | \textcircled{1}R-T-M | \textcircled{2}R-M | |
|---|---|---|---|
| | COMPOUND | COMPOUND | |
| | AREA | AREA | |
| SAMPLE | RATIO | RATIO | \textcircled{1} + \textcircled{2} |
| No. | (%) | (%) | (%) |
| COMPARATIVE | 0.0 | 1.1 | 1.2 |
| EX. 1 | | | |
| EXAMPLE 2 | 1.4 | 1.0 | 2.4 |
| EXAMPLE 3 | 0.9 | 1.3 | 2.1 |

What is claimed is:

1. A sintered R-T-B based magnet, comprising:
a main phase formed of an R₂T₁₄B compound (R is a rare-earth element and contains at least one selected from the group consisting of Nd, Pr and Ce; and T is Fe, or Fe and Co) compound; and
a grain boundary phase at grain boundaries of the main phase,
wherein the grain boundary phase contains an R-T-M compound (M is at least one selected from the group consisting of Ga, Cu, Zn, Al and Si) and an R-M compound,
wherein where:
R has a content (at o) represented as [R],
T has a content (at %) represented as [T], and
M has a content (at %) represented as [M],
the contents of R, T and M in the R-T-M compound satisfy the relationships of 0.15≤[R]/([R]+[T]+[M])≤0.3, [T]/([R]+[T]+[M])≥0.6, and 0.015≤[M]/([R]+[T]+[M])≤0.1, and
the contents of R and M in the R-M compound satisfy the relationships of 0.25≤[R]/([R]+[T]+[M])≤0.7 and 0.1<[M]/([R]+[T]+[M])≤0.3, and
wherein in any cross-section of the sintered R-T-B based magnet, a sum of an area ratio of the R-T-M compound and an area ratio of the R-M compound is not lower than 1.5% and not higher than 3.5%, the area ratio of the R-T-M compound is not lower than 0.4% and not higher than 2.5%, and the area ratio of the R-M compound is not lower than 0.4% and not higher than 2.5%.

2. The sintered R-T-B based magnet of claim 1,
wherein the sintered R-T-B based magnet contains Ga and Cu, and
wherein a sum of a content of Ga and a content of Cu is not lower than 0.25 mass % and not higher than 2 mass %.

3. The sintered R-T-B based magnet of claim 1,
wherein the sintered R-T-B based magnet contains Ga and Cu, and
wherein a sum of a content of Ga and a content of Cu is not lower than 0.25 mass % and not higher than 0.65 mass %.

4. The sintered R-T-B based magnet of claim 1, wherein R is contained in the sintered R-T-B based magnet at a content not lower than 28.5 mass % and not higher than 30.0 mass %.

5. The sintered R-T-B based magnet of claim 1, wherein Tb is contained in the sintered R-T-B based magnet at a content not higher than 0.2 mass % (including 0 mass %), and Dy is contained in the sintered R-T-B based magnet at a content not higher than 0.4 mass % (including 0 mass %).

6. The sintered R-T-B based magnet of claim 1, wherein the sintered R-T-B based magnet includes a portion in which at least one of a concentration of Nd and a concentration of Pr gradually decreases from a surface toward an interior thereof.

7. The sintered R-T-B based magnet of claim 1, wherein the sintered R-T-B based magnet includes a portion in which a concentration of M gradually decreases from a surface toward an interior thereof.

8. The sintered R-T-B based magnet of claim 1, wherein the sintered R-T-B based magnet includes a portion in which at least one of a concentration of Tb and a concentration of Dy gradually decreases from a surface toward an interior thereof.
